(19) United States
(12) Patent Application Publication
(10) Pub. No.: US 2007/0158020 A1
(43) Pub. Date: Jul. 12, 2007

(54) Method for modificating fluoropolymers and their application

(76) Inventors: Chen-Yuan Tu, Tao-Yuan (TW); Ying-Ling Liu, Tao-Yuan (TW); Kueir-Rarn Lee, Tao-Yuan (TW); Juin-Yih Lai, Tao-Yuan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/326,407

(22) Filed: Jan. 6, 2006

(51) Int. Cl. B32B 37/00

(52) U.S. Cl. 156/272.6; 264/483

(57) ABSTRACT

The present invention discloses a method for modificating a fluoropolymer. First, a fluoropolymer is provided, and then a hydrogen plasma treatment is performed on the fluoropolymer, so that C—H group is introduced to the surface of the fluoropolymer to form an intermediate. Next, an ozone treatment is performed on the intermediate, wherein the C—H group serves as ozone accessible site to form peroxide, and a first modified fluoropolymer is then formed. Finally, a grafting polymerization is initiated from the peroxide of the first modified fluoropolymer in the presence of a composition comprising at least one functional monomer, so as to form a second modified fluoropolymer. Furthermore, this invention also discloses methods for fabricating metal-clad laminates.

### BACKGROUND OF THE INVENTION

1. Field of the Invention

The present invention is generally related to modifying fluoropolymers, and more particularly to modifying fluoropolymers with sequential hydrogen plasma/ozone treatments and surface-initiated polymerization, and application in the fabrication of metal-clad laminates.

2. Description of the Prior Art

Polytetrafluoroethylene (PTFE) is an attractive material for using in flexible printed circuit boards, multi-layer electronic packages, low friction films, protective sealing and biomedical fields. The wide applications of PTFE are basing on its outstanding bulk and surface properties, such as high thermal stability, excellent chemical inertness, low dielectric constants, low water sorption, extremely frictional resistance and low surface energy. However, the extremely hydrophobic and poor adhesive properties of PTFE limit its performance in application. To introduction particular functional groups onto the polymer film surface could improve the performance and make it promising in other practical application. A lot of attempts focusing on improving the surface properties of PTFEs have been reported. Some approaches are chemical etching with sodium naphthalene, UV-lasers, electron and ion beams irradiation, ⁶⁰Co g-rays irradiation and plasma modification.

Among these methods, plasma treatments, including plasma polymerization and plasma induced grafting polymerization, are attractive for their high efficiency. However, both plasma polymerization and plasma-induced grafting polymerization involves complicated processes. The complicated steps of plasma grafting polymerization process in vacuum system are the knotty problem for applying in industrial manufacture. Control of the molecular weights and welldefined macromolecular architectures are almost impossible while employing the plasma techniques on PTFE surface modifications. Therefore, new modification method for fluoropolymers is still needed corresponding to both economic effect and utilization in industry.

### SUMMARY OF THE INVENTION

In accordance with the present invention, new method for modifying fluoropolymers is provided that substantially overcomes the drawbacks of the above problems mentioned from the conventional system, and can be applied in the fabrication of metal-clad laminates.

An attempt of applying ozone treatment to surface modification of PTFE film, a hydrogen plasma treatment was applied to PTFE films for incorporation of some C—H groups on the film surface. Therefore, the PTFE surface modified by hydrogen plasma possesses the hydrocarbon surface and PTFE bulk characteristics to susceptible to ozone treatment as other polymer.

One object of the present invention is to apply ozone treatment to surface modification of fluoropolymer. Originally, ozone process is restricted for PTFE modification because of the strong bonding energy of C—F bonds in PTFE structure. However, this invention employs sequential hydrogen plasma/ozone treatments to incorporate hydrocarbons and then convert the hydrocarbons to alkylperoxide and hydroperoxide groups.

Another object of the present invention is to provide a new method for the low temperature direct lamination of metal to fluoropolymer surfaces under atmospheric conditions and in the absence of an added adhesive. The advantages of the present invention are obtained by providing a method for the modification of fluoropolymer via, sequential hydrogen plasma/ozone treatments and surface-initiated polymerization of an appropriate functional monomer at the lapped interface between the fluoropolymer and the selected metal. Preferably, a low grafting/lamination temperature is selected to be substantially below the melting or sintering temperature of the fluoropolymer. Desirably, radio frequency of hydrogen plasma with low plasma power is selected for the treatment of the fluoropolymer to minimize the undesirable over-oxidation, etching or sputtering of the fluoropolymer surface. Therefore, this present invention does have the economic advantages for industrial applications.

Accordingly, the present invention discloses a method for modificating a fluoropolymer. First, a fluoropolymer is provided, and then a hydrogen plasma treatment is performed on the fluoropolymer, so that C—H group is introduced to the surface of the fluoropolymer to form an intermediate. Next, an ozone treatment is performed on the intermediate, wherein the C—H group serves as ozone accessible site to form peroxide, and a first modified fluoropolymer is then formed. Finally, a grafting polymerization is initiated from the peroxide of the first modified fluoropolymer in the presence of a composition comprising at least one functional monomer, so as to form a second modified fluoropolymer. Furthermore, this invention also discloses methods for fabricating metal-clad laminates.

### DESCRIPTION OF THE PREFERRED EMBODIMENTS

What probed into the invention are a method for modificating fluoropolymers and their application. Detailed descriptions of the production, structure and elements will be provided in the following in order to make the invention thoroughly understood. Obviously, the application of the invention is not confined to specific details familiar to those who are skilled in the art. On the other hand, the common elements and procedures that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

In a first embodiment of the present invention, a method for modificating a fluoropolymer is disclosed. First, a fluoropolymer is provided. Next, a hydrogen plasma treatment is performed on the fluoropolymer, so that C—H group is introduced to the surface of the fluoropolymer to form an intermediate. Afterwards, an ozone treatment is performed on the intermediate, wherein the C—H group serves as ozone accessible site to form peroxide, and a first modified fluoropolymer is then formed. Finally, a grafting polymerization, especially thermal grafting polymerization, is initiated from the peroxide of the first modified fluoropolymer in the presence of a composition comprising at least one functional monomer, so as to form a second modified fluoropolymer. Additionally, the second modified fluoropolymer can be used in the fabrication of metal-clad laminates.

In this embodiment, the fluoropolymer comprises any one or any combination of the group consisting of: poly(tetrafluoroethylene)(PTFE), copolymers of tetrafluoroethylene and hexafluoropropylene, copolymers of tetrafluoroethylene and perfluoro(propyl vinyl ether), copolymers of tetrafluoroethylene and perfluoro-2,3-dimethyl-1,3-dioxole, copolymers of tetrafluoroethylene and vinyl fluoride, poly(vinyl fluoride), poly(vinylidene fluoride), polychlorotrifluorethylene, vinyl fluoride/vinylidene fluoride copolymers, and vinylidene fluoride/hexafluoroethylene copolymers. Besides, the fluoropolymer is in the form selected from the group consisting of: film, sheet, slab, fiber, rod, powder, composite or porous membrane.

In this embodiment, the hydrogen plasma treatment is performed with a plasma power in the range of 10 W to 70 W, the duration ranges from 5 to 300 seconds, and the frequency ranges from 5 kHz to 50 kHz. Low plasma power is selected for the treatment of the fluoropolymer to minimize over-oxidation, etching or sputtering of the fluoropolymer surface. Furthermore, the ozone treatment is performed with O₃/O₂ mixture stream, the ozone concentration ranges from 5 to 50 g/m³, and the duration ranges from 5 to 30 minutes. The ozone treatment is controlled to introduce alkyl-peroxide and hydroxyl-peroxide species on the fluoropolymer to initiate the subsequent grafting polymerization. Moreover, the grafting polymerization comprises controlled/living free radical polymerization. The grafting polymerization is performed at a temperature substantially below the melting point or sintering temperature of the fluoropolymer. Additionally, the temperature of the grafting polymerization is higher than the peroxide decomposition temperature (higher than 70° C.), and the grafting polymerization is carried out under atmospheric conditions and in the absence of an added polymerization initiator.

In the mentioned grafting polymerization, the functional monomer has at least one vinyl groups or at least one allyl group. The functional monomer comprises one of the group consisting of: hydroxy methacrylate, amine methacrylate, hydroxylethyl acrylate, N-hydroxylmethylmethacrylamide, acrylamide (AAm), acrylic acid (AAc), glycidyl methacrylate (GMA), 2-(2-bromoisobutyryloxy) ethyl acrylate (BIEA), sodium 4-styrenesulfonate (NaSS) and their derivatives. When the functional monomer is sodium 4-styrenesulfonate (NaSS), the method for modificating the fluoropolymer further comprises a protonization treatment to convert the sodium sulfonate group to hydrogen sulfonate group. In a preferred example of this embodiment, the functional monomer has at least one epoxy group (e.g. glycidyl methacrylate, allyl glycidyl ether), and the method further comprises a curing reaction to open epoxy group. The curing agent comprises any one or any combination of the group consisting of: compound with at least one carboxylic acid group (e.g. acetic acid), compound with at least one amine group (e.g. allyl amine, ethylene diamine), compound with at least one hydroxyl group.

In another preferred example of this embodiment, the funtional monomer has at least one vinyl group with nitrogen heteroatoms or nitrogen functionalities in the pendant vinyl group(s). In still another preferred example, the funtional monomer has at least one allyl group with nitrogen heteroatoms or nitrogen functionalities in the pendant allyl group(s). Moreover, some funtional monomers are listed as following: vinyl-containing monomer, 1-vinyl imidazole, glycidyl methacrylate, allyl glycidyl ether, 1-vinyl imidazole (VIDZ), 1-allyl imidazole, 2-vinyl pyridine (2VP), 4-vinyl pyridine (4VP), 2,4,6-triallyloxy-1,3,5-triazine, 1,2,4-trivinylcyclohexane, triallyl-1,3,5-benzenetricarboxylate, epoxy-containing monomer.

In a second embodiment of the present invention, a method for the lamination of a metal to a fluoropolymer is disclosed. First, a fluoropolymer is provided. Next, a hydrogen plasma treatment is performed on the fluoropolymer, so that C—H group is introduced to the surface of the fluoropolymer to form a first intermediate. Afterwards, an ozone treatment is performed on the first intermediate, wherein the C—H group serves as ozone accessible site to form a peroxide, and a second intermediate is then formed. Finally, a grafting polymerization, especially thermal grafting polymerization, is initiated from the peroxide of the second intermediate, wherein the grafting polymerization is performed with concurrent lamination of a metal in the presence of a composition comprising at least one functional monomer at a lapped interface between the fluoropolymer and the metal. The metal comprises copper and its alloys. Furthermore, the selections or operational parameters of fluoropolymer, hydrogen plasma treatment, ozone treatment, peroxide, grafting polymerization, and functional monomer are described in the first embodiment.

In the above preferred embodiments, the present invention applies ozone treatment to surface modification of fluoropolymer. Originally, ozone process is restricted for PTFE modification because of the strong bonding energy of C—F bonds in PTFE structure. However, this invention employs sequential hydrogen plasma/ozone treatments to incorporate hydrocarbons and then convert the hydrocarbons to alkylperoxide and hydroperoxide groups. On the other hand, this invention provides a new method for the low temperature direct lamination of metal to fluoropolymer surfaces under atmospheric conditions and in the absence of an added adhesive. The advantages of the present invention are obtained by providing a method for the modification of fluoropolymer via, sequential hydrogen plasma/ozone treatments and surface-initiated polymerization of an appropriate functional monomer at the lapped interface between the fluoropolymer and the selected metal. Preferably, a low grafting/lamination temperature is selected to be substantially below the melting or sintering temperature of the fluoropolymer. Desirably, radio frequency of hydrogen plasma with low plasma power is selected for the treatment of the fluoropolymer to minimize the undesirable over-oxidation, etching or sputtering of the fluoropolymer surface. Therefore, this present invention does have the economic advantages for industrial applications.

To sum up, the present invention discloses a method for modificating a fluoropolymer. First, a fluoropolymer is provided, and then a hydrogen plasma treatment is performed on the fluoropolymer, so that C—H group is introduced to the surface of the fluoropolymer to form an intermediate. Next, an ozone treatment is performed on the intermediate, wherein the C—H group serves as ozone accessible site to form peroxide, and a first modified fluoropolymer is then formed. Finally, a grafting polymerization is initiated from the peroxide of the first modified fluoropolymer in the presence of a composition comprising at least one functional monomer, so as to form a second modified fluoropolymer. Furthermore, this invention also discloses methods for fabricating metal-clad laminates.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A method for modificating a fluoropolymer, comprising:
providing a fluoropolymer;
performing a hydrogen plasma treatment on the fluoropolymer to form an intermediate; and
performing an ozone treatment on the intermediate to form a first modified fluoropolymer.

2. The method according to claim 1, wherein the hydrogen plasma treatment is performed to introduce C—H group to the surface of the fluoropolymer, so as to form the intermediate.

3. The method according to claim 2, wherein the C—H group of the intermediate serves as ozone accessible site to form peroxide under the ozone treatment.

4. The method according to claim 3, wherein the peroxide comprises alkyl-peroxide and hydroxyl-peroxide.

5. The method according to claim 1, wherein the fluoropolymer comprises any one or any combination of the group consisting of: poly(tetrafluoroethylene)(PTFE), copolymers of tetrafluoroethylene and hexafluoropropylene, copolymers of tetrafluoroethylene and perfluoro(propyl vinyl ether), copolymers of tetrafluoroethylene and perfluoro-2,3-dimethyl-1,3-dioxole, copolymers of tetrafluoroethylene and vinyl fluoride, poly(vinyl fluoride), poly(vinylidene fluoride), polychlorotrifluorethylene, vinyl fluoride/vinylidene fluoride copolymers, and vinylidene fluoride/hexafluoroethylene copolymers.

6. The method according to claim 1, wherein the fluoropolymer is in the form selected from the group consisting of: film, sheet, slab, fiber, rod, powder, composite or porous membrane.

7. The method according to claim 1, wherein the hydrogen plasma treatment is performed with a plasma power in the range of 10 W to 70 W.

8. The method according to claim 1, wherein the hydrogen plasma treatment duration ranges from 5 to 300 seconds.

9. The method according to claim 1, wherein the frequency of the hydrogen plasma treatment ranges from 5 kHz to 50 kHz.

10. The method according to claim 1, wherein the ozone treatment is performed with O₃/O₂ mixture stream.

11. The method according to claim 10, wherein the ozone concentration ranges from 5 to 50 g/m³.

12. The method according to claim 1, wherein the ozone treatment duration ranges from 5 to 30 minutes.

13. The method according to claim 1, further comprises a grafting polymerization on the first modified fluoropolymer in the presence of a composition comprising at least one functional monomer, so as to form a second modified fluoropolymer.

14. The method according to claim 13, wherein the grafting polymerization is carried out in the absence of an added polymerization initiator.

15. The method according to claim 13, wherein the grafting polymerization is performed at a temperature substantially below the melting point or sintering temperature of the fluoropolymer.

16. The method according to claim 13, wherein the grafting polymerization comprises controlled/living free radical polymerization.

17. The method according to claim 13, wherein the temperature of the grafting polymerization is higher than 70° C.

18. The method according to claim 13, wherein the grafting polymerization is performed under atmospheric conditions.

19. A method according to claim 13, wherein the functional monomer has at least one vinyl groups or at least one allyl group.

20. A method according to claim 19, wherein the functional monomer comprises one of the group consisting of: hydroxy methacrylate, amine methacrylate, hydroxylethyl acrylate, N-hydroxylmethylmethacrylamide, acrylamide (AAm), acrylic acid (AAc), glycidyl methacrylate (GMA), 2-(2-bromoisobutyryloxy) ethyl acrylate (BIEA), sodium 4-styrenesulfonate (NaSS) and their derivatives.

21. A method according to claim 20, wherein the functional monomer is sodium 4-styrenesulfonate (NaSS), and the method further comprises a protonization treatment to convert the sodium sulfonate group to hydrogen sulfonate group.

22. A method according to claim 13, wherein the functional monomer has at least one epoxy group, and the method further comprises a curing reaction to open epoxy group.

23. A method according to claim 22, wherein the curing agent comprises any one or any combination of the group consisting of: compound with at least one carboxylic acid group, compound with at least one amine group, compound with at least one hydroxyl group.

24. A method according to claim 13, wherein the funtional monomer has at least one vinyl group with nitrogen heteroatoms or nitrogen functionalities in the pendant vinyl group(s).

25. A method according to claim 13, wherein the funtional monomer has at least one allyl group with nitrogen heteroatoms or nitrogen functionalities in the pendant allyl group(s).

26. A method according to claim 13, wherein the funtional monomer comprises one of the group consisting of: a vinyl-containing monomer, 1-vinyl imidazole, glycidyl methacrylate, allyl glycidyl ether, 1-vinyl imidazole (VIDZ), 1-allyl imidazole, 2-vinyl pyridine (2VP), 4-vinyl pyridine (4VP), 2,4,6-triallyloxy-1,3,5-triazine, 1,2,4-trivinylcyclohexane, triallyl-1,3,5-benzenetricarboxylate, an epoxy-containing monomer.

27. A method according to claim 13, wherein the second modified fluoropolymer is used in the fabrication of metal-clad laminates.

28. A method for the lamination of a metal to a fluoropolymer, comprising:
providing a fluoropolymer;
performing a hydrogen plasma treatment on the fluoropolymer, so that C—H group is introduced to the surface of the fluoropolymer to form a first intermediate;
performing a ozone treatment on the first intermediate, wherein the C—H group serves as ozone accessible site to form a peroxide, and a second intermediate is then formed; and
performing a grafting polymerization initiated from the peroxide of the second intermediate, wherein the grafting polymerization is performed with concurrent lamination of a metal in the presence of a composition comprising at least one functional monomer at a lapped interface between the fluoropolymer and the metal.

29. The method according to claim 28, wherein the metal comprises copper and its alloys.
